(19) United States
(12) Patent Application Publication
(10) Pub. No.: US 2005/0147735 A1
(43) Pub. Date: Jul. 7, 2005

(54) Lubricious, biocompatible coatings for medical devices

(76) Inventors: Michael D. Lowery, Vista, CA (US); Harish C. Makker, Mission Viejo, CA (US); Can B. Hu, Irvine, CA (US)

Correspondence Address: Advanced Medical Optics, Inc.;Legal Department, 1700 E. St. Andrew Place, Santa Ana, CA, 92705, US

(21) Appl. No.: 11/021,869

(22) Filed: Dec. 22, 2004

Related U.S. Application Data
(60) Provisional application No. 60/532,390, filed on Dec. 23, 2003.

(51) Int. Cl. B05D 3/00

(52) U.S. Cl. 427/2.1

(57) ABSTRACT

A lubricous coating composition and methods for using same are provided. Specifically, a composition suitable for providing hydrophobic polymer surfaces with lubricious coatings is described wherein a polyolefin surface is reiteratively treated with hydrophilic polymer solutions and cross-linking solutions. Methods for reiterative coating polymer surfaces are also provided including methods wherein the hydrophobic polymer surface is pretreated using plasma energy.

### RELATED APPLICATIONS

The present application claims priority to U.S. provisional patent application Ser. No. 60/562,390 filed Dec. 23, 2003.

### FIELD OF THE INVENTION

The present invention relates to lubricous, biocompatible coatings suitable for use with medical devices. More specifically the present invention provides compositions and methods for providing surgical instruments such as intraocular lens inserters with stable, uniform, biocompatible surfaces having low coefficients of friction.

### BACKGROUND OF THE INVENTION

Intraocular lenses (IOLs) were first used as a replacement for damaged natural crystalline lenses in 1949. These early IOL experiments were conducted in England by Dr. Howard Ridley an RAF ophthalmologist. Dr Ridley first observed acrylate polymer biocompatibility in the eyes of pilots who had sustained ocular injuries from polymethylmethacrylate (PMMA) shards when their aircraft canopies were shattered. However, it took nearly thirty years for ophthalmologists to embrace IOL implantation as a routine method for restoring vision in patients suffering from diseased or damaged natural crystalline lenses.

Early IOLs were made from PMMA because of its proven biocompatibility. Polymethylmethacrylate is a ridged polymer and requires a 5 mm to 7 mm incision. Incision size is directly related to patient trauma, discomfort and healing times. Moreover, incisions sizes in the 5 mm to 7 mm range generally require sutures further increasing procedural complexity and patent discomfort. Lens size dictates incision size and lens size is in turn determined by the size of the capsular sac and natural crystalline lens. Thus lenses made from a rigid polymer such as PMMA require an incision size at least as large as the minimum IOL dimension which is generally 5.5 mm on average.

In an effort to decrease incision size and corresponding patient discomfort, recovery time and procedural complexity a number of IOL designs suitable for insertion through small incisions have been developed; most notably foldable IOLs. Foldable IOLs are made from non-rigid, or flexible polymers including hydrophobic acrylics, hydrophilic hydrogels, silicone elastomers and porcine collagen. Intraocular lenses made from these materials can be folded or rolled into implantable configurations having minimum dimensions suited for 3 mm incisions, or less.

Hard PMMA IOLs are inserted through a surgical incision using forceps. However, IOLs made from flexible polymers are not easily manipulated using forceps. Furthermore foldable IOLs require restraining devices to maintain their folded configuration prior to and during implantation. Thus the development of foldable IOLs has lead to the evolution of deployment devices, commonly referred to as inserters.

The typical inserter is similar to a syringe in that it comprises a plunger-like device that engages the folded or rolled IOL restrained within a barrel-like tip. As pressure is exerted on the plunger the IOL is pushed out of the tip and into the eye. Once inside the capsular sac the IOL unfolds. The IOL may also include haptics which are spring-like arms that help hold the IOL in place. Sutures are generally not required with modern IOLs.

The IOL inserter tip is generally made from polymers such as polyolefins which are highly hydrophobic. When a polymer IOL is pushed through the polyolefin tip frictional forces impede the IOL's progress requiring increasing amounts of force. As the pressure is increased the folded polymer IOL will tend to expand circumferentially inside the inserter tip as longitudinal movement is restricted by friction. If the friction coefficient of the tip relative to the lens is too great the lens may seize in the inserter tip making IOL delivery impossible. Moreover, the inserter tip may crack (craze) or even fracture as longitudinal pressure is increased resulting in IOL delivery failure.

In an effort to minimize friction within the inserter tip and ease IOL deployment numerous lubricious coatings have been developed. The lubricious coatings are generally composed of biocompatible hydrophilic polymers applied directly to the inserter interior surface. However, the type and amount of lubricious polymer must be closely regulated to prevent transfer from the inserter tip's interior surface to the IOL. If excessive amount of lubricious materials are transferred to the IOL during insertion the lens surface will become streaked and clouded. This can result in permanent damage to the IOL's optical clarity and is unacceptable.

In order to prevent lubricious coating transfer from the inserter to the IOL's surface it would be desirable to chemically bond the coating polymer directly to the polyolefin tip. However, chemical, or covalent bonding is not practical for many biocompatible polymers because the polymer may lose its lubricous properties once bonded. Moreover, the physical constraints due to the small volume of the inserter tip's barrel limit the type of chemistry that can be used and can result in inconsistent coatings and surfaces that lack uniformity. Furthermore, many covalent bonding reactions require conditions and reagents that are incompatible with the preferred polyolefins used to make the inserter tip and the requirements for absolute biocompatibility.

Therefore, there remains a need for lubricous coating materials and methods that provide IOL inserter tips with a low coefficient of friction, have high biocompatibility, can be uniformly applied and do not transfer to or streak the optical surfaces of an IOL.

### SUMMARY OF THE INVENTION

The present invention provides methods and compositions for providing medical devices such as surgical instruments with biocompatible lubricious coatings. In one embodiment of the present invention the surgical device is an intraocular lens (IOL) inserter.

The coating of the present invention can be used to provide IOL inserters, specifically, inserter tips, with uniform stable coatings having a low coefficient of friction. The inserter tip is generally composed of polyolefins such as, but not limited to, polypropylene and polyethylene. In one embodiment of the present invention a polypropylene IOL inserter tip is provided with a coating comprising a cross-linked biocompatible polymer.

In another embodiment of the present invention the polypropylene IOL inserter tip is provided with a coating comprising a cross-linked biocompatible polymer blend.

Another aspect of the present invention includes a method for providing a uniform stable lubricious coating for surgical devices such as IOL inserters, specifically the inserter tip.

In one embodiment of the present invention the method includes first applying a biocompatible polymer solution to the surface of a polyolefin IOL inserter tip followed by applying a cross-linking agent.

Another embodiment of the present invention includes first applying a biocompatible polymer solution to the surface of a polyolefin IOL inserter tip followed by applying a cross-linking agent followed by applying a second biocompatible polymer solution wherein said first and second biocompatible polymer solution may be the same or different.

In yet another embodiment of the present invention the method includes first applying a biocompatible polymer solution to the surface of a polyolefin IOL inserter tip followed by applying a cross-linking agent followed by applying a second biocompatible polymer solution wherein said first and second biocompatible polymer solution may be the same or different. This is followed by another application of a second cross-linking agent and/or second biocompatible polymer wherein the first and second biocompatible polymer agent and or second cross-linking agent may be the same or different.

Moreover, this reiterative coating process can be repeated numerous times and in different orders, such as, but not limited top B-A-B, B-A-A-B, B-A-B-A, B-A-A-A-B and so on where A is the cross-linking agent and B is the biocompatible polymer.

In another embodiment the crosslinker can be combined with a hydrophilic polymer, such as polyvinylpyrrolidone (PVP) and used as the first coating followed by a second polymer. This configuration will be represented as AB-A-AB, or AB-B-B-A, or AB-B-B-AB and so on where AB is the crosslinker/hydrophilic polymer mixture and B is another, or the same biocompatible polymer as defined elsewhere.

Furthermore, the biocompatible polymer can be a polymer blend, a co-polymer or any combination thereof. Additionally, the biocompatible polymer can be hydrophilic or hydrophobic or a polymer blend of at least one hydrophilic and at least one hydrophobic polymer.

In one specific, non-limiting embodiment, the cross-linking agent is an aldehyde and the biocompatible polymer is a blend of two hydrophilic polymers.

In one embodiment the aldehyde is glutaraldehyde and the hydrophilic polymer blend comprises polyethylenimine (PEI) and polyvinylpyrrolidone (PVP) and the coating is applied using a B-A-B method.

In yet another embodiment of the present invention the polyolefin surface may be treated using chemical or physical processes prior to applying the coating solution.

### DETAILED DESCRIPTION

The present invention relates to providing medical devices with lubricious coatings. In particular, the present invention is directed at providing an intraocular lens (IOL) with a lubricious coating that does not transfer to the IOL's surface during insertion. Prior art methods for providing IOL inserters with lubricous coatings can result in transfer of the lubricating component, generally a polymer, to the surface of the IOL resulting in permanent damage to the lens. In other prior art embodiment, the lubricant is applied such that the lubricant does not damage the IOL, however, many of these inserters have short shelf lives thus reducing the medical devices commercial value. Moreover, in other commercial embodiments the coating processes are expensive to perform or involve chemistry that is not compatible with many inserter materials.

Most modern IOLs have been designed for insertion into incisions of between 3 mm-4 mm or less. Furthermore, new IOL materials are presently being developed that can be inserted into 2 mm or smaller incisions. Therefore, present and future IOL surgical producers require micro-surgical tools. The micro-surgical tools used for IOL implantation comprise essentially two parts, an inserter and an inserter tip. In most configurations the inserter is a stainless steel, or other metal alloy, device loosely resembling a syringe having proximal and distal ends. At the proximal end is a means for controlling the advancement of a plunger-like device. The plunger like device advances the IOL through a disposable polymer tip installed at the inserter's distal end. The ophthalmologist deploys the IOL by slowly advancing the plunger-like device through the disposable tip until the IOL enters the capsular sac. The IOL then unfolds and the inserter tip is removed from the eye.

Extremely small incision sizes made possible by advances in lens design and micro-surgical equipment has resulted in IOL inserter tips having extreme narrow inner diameters. These narrow diameters make it necessary for the inner surfaces be highly lubricious in order to advance the IOL smoothly and precisely. Moreover, the inserter tips must also have biocompatible lubricious coatings that are even and homogenous. However, the extremely small volume and narrow constraints associated with new IOL inserter tips provides significant challenges to the polymer chemist seeking to provide microsurgical devices with homogenous, highly-lubricious, biocompatible coatings.

The present inventors have developed a highly lubricous, biocompatible coating that can be applied evenly to the inner surfaces of micro-surgical devices including disposable, polyolefin IOL inserter tips. Polymer selection is an important consideration in developing a polymer coating for implantable medical devices. Biocompatible as used here is defended to include any polymer that does not cause injury or death to the animal or induce an adverse reaction in an animal when placed in intimate contact with the animal's tissues. Adverse reactions include inflammation, infection, fibrotic tissue formation, cell death, or thrombosis.

Many different biocompatible polymers have been developed including both hydrophilic and hydrophobic classes of materials. However, lubricious biocompatible polymers are generally hydrophilic. Two examples of lubricous, hydrophilic biocompatible polymers suitable for use in accordance with the teachings of the present invention include polyvinylpyrrolidone and polyethylene oxide (PEO). These examples are non-limiting and persons having ordinary skill in the art of polymer chemistry would immediately recognized that there are numerous other polymers, including homopolymers and copolymers, that can be used as coatings for IOL inserter tips.

The present inventors have developed an eloquent highly controllable process for providing medical devices, specifically IOL inserter tips, with biocompatible lubricious coatings. Generally, the IOL inserter tip is composed of a flexible polyolefin such as polypropylene or polyethylene. These are non-limiting examples and the coating process of the present invention, together with the coating materials disclosed herein, will work with many different polymer IOL inserter tips. The coating process of the present invention can best be described as a reiterative coating process where a first reagent, generally at least one lubricous, biocompatible, polymer, is applied to the medical device surface and then dried. In a second step a cross-linking compound, such as an aldehyde is then applied to the coated surface. The surface is dried again and a third reagent, again generally a lubricous, biocompatible, polymer solution, is applied to the surface and then allowed to dry. There are limitless variations on this scheme and a wide range of different coating solutions and cross-linking agent that can be applied.

In one embodiment of the present invention the polyolefin inserter tip is first treated with an energy source such as plasma generator. Although not wishing to be bound by this theory, it is believed that plasma treating a polyolefin surface reduces surface inconstancies and provides a reactive substrate by removing hydrogen atoms form the polyolefin backbone.

The coating solutions of the present invention can be applied by any means known to those skilled in the material arts or chemical sciences. For example, the coating solutions can be sprayed onto the surfaces of the medical device or the medical device can be dipped into a coating solution. Rolling and brushing techniques may also be useful but can restrict the medical devices' minimum size. For convenience the coating compositions of the present invention will be designated as follows: biocompatible lubricious coating solutions are “B.” Cross-linking coating solutions will be designated “A.” In some embodiments the designation A′ (A prime, A double prime etc.) or B′ (B prime, B double prime) may be used (prime, referring to a different coating composition but applied in the same order).

Suitable cross-linking solutions include, but are not limited to aldehydes such as glutaraldehye and are generally prepared using highly pure water such as distilled water (DW), deionized water (DI), or reverse osmosis water (RO).

Suitable lubricious polymers include biocompatible, generally hydrophilic, polymers that are dissolved in compatible solvents including low molecular weight alcohols. Optionally, a catalyst can also be added to the solvent either before or after polymer addition.

### EXAMPLES

### Example 1

Providing a Polypropylene Iol Inserter Tip with a Lubricious Coating

I. Two coating solutions were prepared:
A. Cross-linking Solution
   1.8 grams of 50% glutaraldehyde (e.g. Sigma Chemicals Catalogue Number G7651) is added to approximately 150 mL of deionized water and qs to 180 grams with DI water.
B. Lubricious Coating Polymer Solution
   1.5 grams of polyethylenimine (PEI) (e.g. Sigma Chemical Catalogue number P3143) and 1.2 grams of high molecular weight (M_{w}) polyvinylpyrrolidone (PVP) (e.g. Sigma Chemical Catalogue number P6755) are added to 150 grams of n-propanol (e.g. Sigma Chemical Catalogue number 25,640-4) to which 0.05 grams of stannous ethylhexanoate (e.g. Sigma Chemical Catalogue number S3252) is added.

II. Surface Preparation

A polypropylene IOL inserter tip (IOL Tip) is plasma treated for five minutes at 500 watts of power in a Model PSO150E Plasma Science plasma chamber. The gas flow rate was set at 30 mL/minute for oxygen and 15 mL/minute for argon.

III. Coating Procedure
a. The IOL Tip was dipped into solution B for 1 minute at room temperature and then dried for 2 hours at 70° C.±3° C.
b. The dried IOL Tip from step “a” was then dipped in solution A for one minute and then dried for 2 hours at 70° C.±3° C.
C. The IOL dried Tip from “step b” was dipped into solution B for 1 minute at room temperature and then dried overnight hours at 70° C.±30° C.

IV. Testing

The lubricity of coated IOL tips (Test IOL Tips) were measured and compared to a “prior art IOL Tip,” referred to herein after as the “Emerald.” Briefly the Emerald is a polypropylene IOL tip having a proprietary coating applied as disclosed in U.S. Pat. No. 5,942,277, the entire contents of which are herein incorporated by reference in their entirety, specifically column 10 beginning at line 58 through column 13 line 60. The Emerald tip represents the “state-of-the-art” in lubricous coatings at the time this application was filed.
a. Testing Methods
   1. Test lenses representing four different diopters (D) were loaded into the test IOL Tip and the Emerald loading zone. A small amount of 1% sodium hyaluronate was added. The test lenses were Advanced Medical Optics AR40e a hydrophobic acrylate IOL
   2. The loaded Test IOL Tips and Emerald were placed in an appropriate sized inserter and mounted onto a torque gage.
   3. The gage was zeroed and loaded inserters were allowed to equilibrate for approximately 5 minutes.

4. The “plunger-like” device of the IOL inserter was advanced and allowed to engage the IOL. After a 30 second dwell time, the IOL was advanced through the full length of the IOL Test Tip or Emerald and the maximum amount of torque required to fully advance the IOL was recorded in Table 1 below.

TABLE 1

| | Number of | Torque in g-cm | Torque in g-cm |
|---|---|---|---|
| IOL D | Samples | Test IOL | Emerald |
| 6 | 7 | 214 ± 24 | 257 ± 35 |
| 20 | 8 | 275 ± 75 | 338 ± 64 |
| 24.5 | 3 | 325 ± 66 | 342 ± 118 |
| 26 | 4 | 250 ± 50 | 425 ± 29 |

Friction impedes an object as it moves across the surface of another object. The less friction there is the more easily the objects will move across each other's surface. Torque is a measure of the force required to move one object across the surface of another. Therefore, the greater the torque required to move object across another, the greater the amount of friction present. Lubricants decrease friction and thus make it easier (i.e. less torque is required) to move objects across each other's surface. Table 1 depicts the experimental results of moving a hydrophobic polymer lens across the surface of a hydrophobic polymer inserter. Both the Test IOL Tip and the Emerald have been provided with lubricious coatings. It can been seen that considerably less torque is required to move the IOL thorough the Test IOL TIP than the industry standard Emerald tip. Therefore, it is logical to conclude that the lubricious coatings of the present invention represent a significant improvement over the state-of-the-art.

The preceding example is merely illustrative and should not be considered limiting. There are many different polymers and cross-linking agents that can be used in accordance with the teachings of the present invention. Moreover, the reiterative coating procedure in Example 1 (B-A-B) should not be considered limiting. Other suitable examples include, but are not limited to B-A-B′; B-A-A′-B; B-A-A-B′; B-A-A-A-B; B-B′-A-B-A′-B-B′ and so on as well as AB-A-AB, or AB-B-B-A, or AB-B-B-AB and so on where AB is the crosslinker/hydrophilic polymer mixture and B is another, or the same biocompatible polymer as defined elsewhere.

1. A lubricious coating for a medical device comprising:
at least one first lubricious polymer applied to at least one surface of said medical device;
at least one cross-linking agent applied to said first lubricious polymer on said surface; and
a second lubricous polymer applied to said at least one cross-linking agent applied to said surface and said first lubricious polymer;
wherein said first and said second lubricous polymer can be the same or different.

2. The lubricious coating for a medical device according to claim 1 wherein said medical device is a polyolefin intraocular lens inserter tip.

3. The lubricious coating for a medical device according to claim 1 wherein said cross-linking agent is glutaraldehyde.

4. The lubricious coating for a medical device according to claim 1 wherein said lubricous polymer is polyvinylpyrrolidone.

5. The lubricious coating for a medical device according to claim 4 wherein said lubricous polymer further comprises polyethylenimine.

6. A method for providing a medical device surface with a lubricious coating comprising:
applying at least one first lubricious polymer to at least one surface of said medical device;
cross-linking said at least one first lubricious polymer using at least one cross-linking agent applied to said first lubricious polymer on said surface; and
applying a second lubricous polymer to said at least one cross-linked first lubricious polymer;
wherein said first and said second lubricous polymer can be the same or different.

7. The method for providing a medical device with a lubricious coating according to claim 6 further comprising the step of plasma treating said at least one surface prior to applying said at least one first lubricious polymer.

8. The method for providing a medical device with a lubricious coating according to claim 6 wherein said medical device is a polyolefin intraocular lens inserter tip.

9. The method for providing a medical device with a lubricious coating according to claim 6 wherein said cross-linking agent is glutaraldehyde.

10. The method for providing a medical device with a lubricious coating according to claim 6 wherein said lubricous polymer is polyvinylpyrrolidone.

11. The method for providing a medical device with a lubricious coating according to claim 10 wherein said lubricous polymer further comprises polyethylenimine.

12. The method for providing a medical device with a lubricious coating according to claim 6 wherein said applying is done using a method selected from the group consisting of spraying, dipping, brushing and coating.

13. A method for providing a polyolefin intraocular lens (IOL) inserter tip surface with a lubricious coating comprising:
a) plasma treating said surface;
b) applying a lubricous coating solution comprising polyethylenimine and polyvinylpyrrolidone;
c) drying said surface;
d) applying a glutaraldehyde solution to said dried surface to form a cross-linked lubricious coating;
e) drying said cross-linked lubricious coating;
f) applying said lubricous coating solution to said dried cross-linked lubricious coating to form a coated IOL inserter tip; and
g) drying said coated IOL inserter tip.

14. The method for providing a medical device with a lubricious coating according to claim 13 wherein said lubricous coating solution further comprises stannous ethylhexanoate.

15. The method for providing a medical device with a lubricious coating according to claim 13 further comprising sterilizing said coated IOL inserted tip.
